(19) United States
(12) Patent Application Publication
(10) Pub. No.: US 2014/0030006 A1
(43) Pub. Date: Jan. 30, 2014

(54) PIVOTAL CONNECTION MECHANISM

(71) Applicant: YU CHIEH LEE, TAINAN (TW)

(72) Inventor: YU CHIEH LEE, TAINAN (TW)

(21) Appl. No.: 13/558,951

(22) Filed: Jul. 26, 2012

(51) Int. Cl. F16C 11/04

(52) U.S. Cl. 403/116

(57) ABSTRACT

A pivotal connection mechanism for pivotally connecting a first and a second rod includes a first and a second connection seat respectively having a fitting surface, on which a rotation-limiting member is provided. The two rotation-limiting members are separately non-rotatably engaged with two rotation-limiting slots separately provided on two outer side surfaces of the first and second rods facing away from each other. A pivot shaft is extended through the first connection seat, the first rod, the second rod, and the second connection seat and locked thereto. With the rotation-limiting members non-rotatably engaged with the rotation-limiting slots on the first and second rods, the first and second connection seats are attached to the first and second rods and do not rotate when the pivot shaft is turned to extend into or loosen from the two rods, enabling the two rods to be conveniently connected to or separated from each other.

### FIELD OF THE INVENTION

The present invention relates to a pivotal connection mechanism, and more particularly to a connection mechanism for pivotally connecting two rods to each other.

### BACKGROUND OF THE INVENTION

A conventional pivotal connection mechanism generally includes a pivot shaft and two washers. The two washers are separately arranged on two outer side surfaces of two rods facing away from each other. The pivot shaft is extended through the two rods and the two washers to be locked thereto. The conventional pivotal connection mechanism with the above-described structure is disadvantageous for use because the washers tend to rotate along with the pivot shaft when the pivot shaft is turned to extend through or loosen from the two rods, and accordingly cause inconveniences in connecting or separating the rods to or from each other.

### SUMMARY OF THE INVENTION

It is therefore a primary object of the present invention to provide an improved pivotal connection mechanism that enables convenient assembling and disassembling of two rods to or from each other, so as to eliminate the disadvantages in the conventional pivotal connection mechanism of the same purpose.

To solve the problems in the conventional pivotal connection mechanism, the pivotal connection mechanism according to the present invention is designed for pivotally connecting a first rod and a second rod to each other, and includes a first connection seat having a first rotation-limiting member provided on a fitting surface thereof; a second connection seat having a second rotation-limiting member provided on a fitting surface thereof; a first rotation-limiting slot provided on an outer side surface of the first rod facing away from the second rod; a second rotation-limiting slot provided on an outer side surface of the second rod facing away from the first rod; and a pivot shaft extended through the first connection seat, the first rod, the second rod, and the second connection seat and locked thereto. The first connection seat is attached to the first rod with the first rotation-limiting member non-rotatably engaged with the first rotation-limiting slot on the first rod, and the second connection seat is attached to the second rod with the second rotation-limiting member non-rotatably engaged with the second rotation-limiting slot on the second rod. With the rotation-limiting members on the connection seats of the pivotal connection mechanism non-rotatably engaged with the rotation-limiting slots on the first and second rods, the first and second connection seats would not rotate along with the pivot shaft when the pivot shaft is turned to extend into or loosen from the two rods, enabling the two rods to be conveniently connected to or separated from each other.

The pivotal connection mechanism of the present invention further includes a wear-resistant and low-friction washer arranged between the first and the second rod. The pivot shaft is extended through the first connection seat, the first rotation-limiting member, the first rod, the washer, the second rod, the second rotation-limiting member and the second connection seat to be locked thereto. With the wear-resistant and low-friction washer, the frictional contact area and the coefficient of friction between the two pivotally connected rods are reduced to minimize the wear thereof, enabling the rods to have prolonged service life and be conveniently turned relative to each other.

The pivot shaft includes a bolt and a matching nut. The bolt has an externally threaded shank being sequentially extended through the first connection seat, the first rotation-limiting member, the first rod, the washer, the second rod, the second rotation-limiting member, and the second connection seat to engage with the nut. The engaged bolt and nut together constitute the pivot shaft that can stably hold to the rods, enabling the rods to be conveniently pivotally connected to or separated from one another and have prolonged service life.

The first connection seat has an outer surface facing away from the first rod. The outer surface of the first connection seat is extended in a direction opposite to the fitting surface of the first connection seat to form a raised first locating seat, which internally defines a round slot matching a head of the bolt, and the bolt head is rotatably received in the round slot. With the bolt head rotatably received in the round slot, the two rods can be easily assembled, and it is able to prevent the bolt head from projecting out of the first connection seat to ensure a beautiful appearance thereof while eliminating the risk of scratching a user or the user's clothes by the bolt head.

The second connection seat has an outer surface facing away from the second rod. The outer surface of the second connection seat is extended in a direction opposite to the fitting surface of the second connection seat to form a raised second locating seat, which internally defines a rotation-limiting slot matching the nut, and the nut is non-rotatably received in the rotation-limiting slot. With the nut non-rotatably received in the rotation-limiting slot, the two rods can be easily assembled to or disassembled from each other, and it is able to effectively prevent the condition of self-loosening of the bolt from the nut. Meanwhile, the nut is not exposed from the second connection seat to ensure a beautiful appearance thereof while eliminating the risk of scratching a user or the user's clothes by the nut.

The first rotation-limiting member has an outer configuration matching an inner configuration of the first rotation-limiting slot on the first rod; and the second rotation-limiting member has an outer configuration matching an inner configuration of the second rotation-limiting slot on the second rod. Thus, the connection seats are effectively prevented from rotating along with the pivot shaft when the latter is turned, and increased connection strength between the connection seats and the rods can be obtained.

The first rotation-limiting member includes a first round stub as a base and a first protrusion radially outward projected from the first round base; and the second rotation-limiting member includes a second round stub as a base and a second protrusion radially outward projected from the second round base.

In an embodiment of the present invention, the pivotally connected first and second rods have a pivot point located at their respective middle area, so that the first and the second rod cross each other and form a foldable scissor linkage.

In another embodiment of the present invention, the pivotally connected first and second rods have a pivot point located close to their respective one end; and the pivotal connection mechanism further includes a first reinforcing cap fixedly fitted on the pivotal end of the first rod to correspond and adjoin to the first connection seat, and a second reinforcing cap fixedly fitted on the pivotal end of the second rod to correspond and adjoin to the second connection seat. The reinforcing caps not only give the pivotal ends of the first and second rods a beautiful appearance, but also prevent them from exposing to an open space to thereby eliminate the risk of scratching a user or the user's clothes by the pivotal ends of the rods.

In the above embodiment, the first rod is further provided near the pivotal end thereof with a fixed first locating dot, and the first reinforcing cap is internally provided with a first locating blind hole or a first undercut for correspondingly engaging with the first locating dot.

In the above embodiment, the second rod is further provided near the pivotal end thereof with a fixed second locating dot, and the second reinforcing cap is internally provided with a second locating blind hole or a second undercut for correspondingly engaging with the second locating dot.

In a further embodiment of the present invention, the first reinforcing cap is integrally formed with the first connection seat, and the second reinforcing cap is integrally formed with the second connection seat.

With the above arrangements, the pivotal connection mechanism of the present invention provides the advantage of allowing two rods to be pivotally connected to or be separated from one another in a convenient manner.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a pivotal connection mechanism according to a first embodiment of the present invention for connecting two link rods of two scissor linkages to one another;

FIG. 2 shows an example of application of the pivotal connection mechanism of the present invention; and

FIG. 3 is an exploded perspective view of a pivotal connection mechanism according to a second embodiment of the present invention for connecting two link rods of a scissor linkage to one another.

### DETAILED DESCRIPTION OF THE PREFERRED EMBODIMENTS

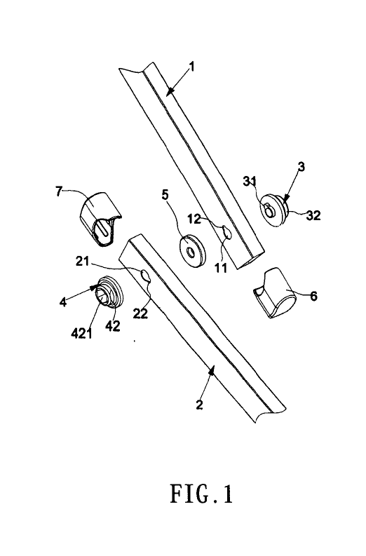

Please refer to FIG. 1 that is an exploded perspective view of a pivotal connection mechanism according to a first embodiment of the present invention for connecting two link rods of two scissor linkages to one another. More specifically, the pivotal connection mechanism of the present invention is used to pivotally connect a first link rod 1 of a first scissor linkage and a second link rod 2 of a second scissor linkage to each other. As shown in FIG. 1, the pivotal connection mechanism in the first embodiment includes a first connection seat 3, a second connection seat 4, a washer 5, a first reinforcing cap 6, a second reinforcing cap 7, a bolt, and a nut.

As can be best seen from FIG. 1, the first link rod 1 has a rectangular-like cross section and is provided close to an end of an outer side surface facing away from the second link rod 2 with a first rotation-limiting slot 12, which includes a pivot hole 11 located at a bottom thereof. The first link rod 1 is also provided closer to the same end with a fixed first locating dot. The second link rod 2 has a rectangular-like cross section and is provided close to an end of an outer side surface facing away from the first link rod 1 with a second rotation-limiting slot 22, which includes a pivot hole 21 located at a bottom thereof. The second link rod 2 is also provided closer to the same end with a fixed second locating dot. The first and the second link rod 1, 2 are structurally similar to each other.

The first connection seat 3 has a fitting surface for bearing on a first side surface of the first link rod 1 facing away from the second link rod 2. On the fitting surface of the first connection seat 3, there is provided a first rotation-limiting member 31, which includes a first round stub as a base and a first protrusion radially outward projected from the first round base. The first rotation-limiting member 31 has an outer configuration matching an inner configuration of the first rotation-limiting slot 12 on the first link rod 1, so that the first rotation-limiting member 31 is non-rotatably received in the first rotation-limiting slot 12. The first connection seat 3 has an outer surface facing away from the first link rod 1. The outer surface of the first connection seat 3 is extended in a direction opposite to the fitting surface to form a raised first locating seat 32, which internally defines a round slot. The first connection seat 3 also internally defines a first through hole, which extends through the first round base of the first rotation-limiting member 31 and a bottom of the round slot.

The second connection seat 4 has a fitting surface for bearing on a second side surface of the second link rod 2 facing away from the first link rod 1. On the fitting surface of the second connection seat 4, there is provided a second rotation-limiting member, which includes a second round stub as a base and a second protrusion radially outward projected from the second round base. The second rotation-limiting member has an outer configuration matching an inner configuration of the second rotation-limiting slot 22 on the second link rod 2, so that the second rotation-limiting member is non-rotatably received in the second rotation-limiting slot 22. The second connection seat 4 has an outer surface facing away from the second link rod 2. The outer surface of the second connection seat 4 is extended in a direction opposite to the fitting surface to form a raised second locating seat 42, which internally defines a rotation-limiting slot 421. The second connection seat 4 also internally defines a second through hole, which extends through the second round base of the second rotation-limiting member and a bottom of the rotation-limiting slot 421.

The washer 5 is wear-resistant and low-friction and is arranged between the first link rod 1 and the second link rod 2.

The nut is non-rotatably received in the rotation-limiting slot 421, while a head of the bolt is rotatably received in the round slot. The bolt has an externally threaded shank being extended through the first through hole of the first connection seat 3, the pivot hole 11 on the first link rod 1, the washer 5, the pivot hole 21 on the second link rod 2, and the second through hole of the second connection seat 4 to engage with the nut.

The first reinforcing cap 6 is internally provided on a side wall with a first locating blind hole, with which the first locating dot is engaged for the first reinforcing cap 6 to fixedly fit on the end of the first link rod 1. The first reinforcing cap 6 is so configured that a part of its rim matches and fitly contacts with a part of the peripheral edge of the first connection seat 3, while another part of its rim matches and fitly contacts with a part of the peripheral edge of the washer 5.

The second reinforcing cap 7 is internally provided on a side wall with a second locating blind hole, with which the second locating dot is engaged for the second reinforcing cap 7 to fixedly fit on the end of the second link rod 2. The second reinforcing cap 7 is so configured that a part of its rim matches and fitly contacts with a part of the peripheral edge of the second connection seat 4, while another part of its rim matches and fitly contacts with another part of the peripheral edge of the washer 5.

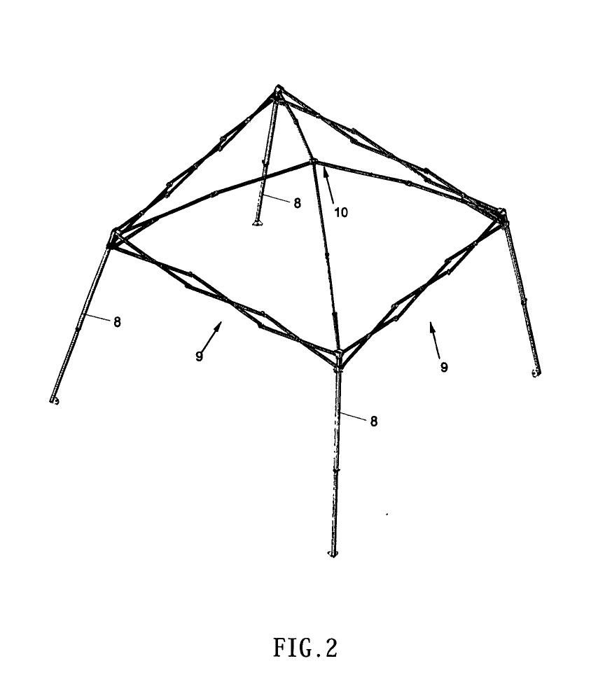

FIG. 2 shows an example of application of the pivotal connection mechanism according to the present invention in a foldable tent. The foldable tent includes four poles 8, four sets of foldable connection devices 9, and a foldable roof frame 10.

The poles 8 are telescopic poles and respectively have a fixed joint provided on an upper end thereof, and a slidable joint movably fitted therearound. Each of the slidable joints is provided with a locking member, with which the slidable joint can be locked to a position relative to a corresponding pole. When the locking member is unlocked, the slidable joint is allowed to slide upward and downward along the pole.

Any two adjacent poles 8 have one set of the foldable connection device 9 connected to between them. Each set of the foldable connection device 9 includes three scissor linkages. Two end portions at one side of the first scissor linkage are separately pivotally connected to the fixed joint and the slidable joint on one of the two adjacent poles 8. Two end portions at one side of the second scissor linkage are separately pivotally connected to two end portions at another side of the first scissor linkage. Two end portions at one side of the third scissor linkage are separately pivotally connected to two end portions at another side of the second scissor linkage, while two end portions at another side of the third scissor linkage are separately pivotally connected to the fixed and the slidable joint on the other one of the two adjacent poles.

The foldable roof frame 10 includes a top member, four sets of struts, and four stretchers. Each set of struts includes an upper strut and a lower strut. The upper strut has an upper end pivotally connected to the top member and a lower end pivotally connected to an upper end of the lower strut. The lower strut is pivotally connected at a lower end to the fixed joint on one of the four poles. Each of the stretchers has a lower end pivotally connected to the slidable joint on a corresponding pole, and an upper end pivotally connected to a corresponding lower strut.

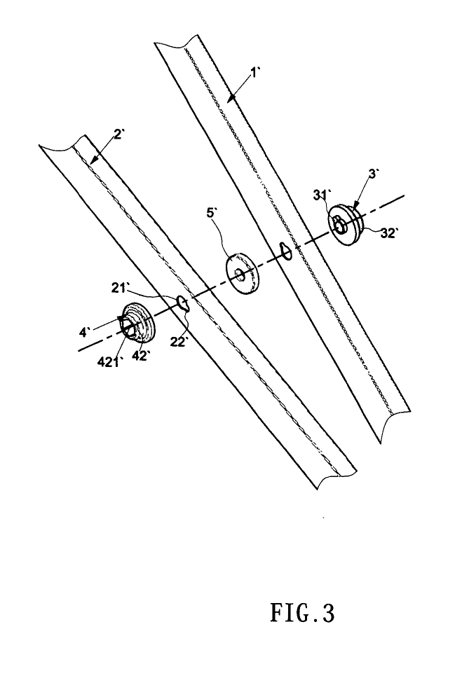

FIG. 3 is an exploded perspective view of a pivotal connection mechanism according to a second embodiment of the present invention for using on a scissor linkage.

More specifically, the pivotal connection mechanism according to the second embodiment of the present invention is used to pivotally connect a first link rod 1′ and a second link rod 2′ of a scissor linkage to each other. The pivotal connection mechanism in the second embodiment includes a first connection seat 3′, a second connection seat 4′, a washer 5′, a bolt, and a nut.

The first link rod 1′ has a rectangular-like cross section and is provided at a middle area of an outer side surface facing away from the second link rod 2′ with a first rotation-limiting slot 12′, which includes a pivot hole 11′ located at a bottom thereof. The first link rod 1′ is also provided close to each of two ends with a fixed first locating dot. The second link rod 2′ has a rectangular-like cross section and is provided at a middle area of an outer side surface facing away from the first link rod 1′ with a second rotation-limiting slot 22′, which includes a pivot hole 21′ located at a bottom thereof. The second link rod 2′ is also provided close to each of two ends with a fixed second locating dot. The first and the second link rod 1′, 2′ are structurally similar to each other.

The first connection seat 3′ has a fitting surface for bearing on a first side surface of the first link rod 1′ facing away from the second link rod 2′. On the fitting surface of the first connection seat 3′, there is provided a first rotation-limiting member 31′, which includes a first round stub as a base and a first protrusion radially outward projected from the first round base. The first rotation-limiting member 31′ has an outer configuration matching an inner configuration of the first rotation-limiting slot 12′ on the first link rod 1′, so that the first rotation-limiting member 31′ is non-rotatably received in the first rotation-limiting slot 12′. The first connection seat 3′ has an outer surface facing away from the first link rod 1′. The outer surface of the first connection seat 3′ is extended in a direction opposite to the fitting surface to form a raised first locating seat 32′, which internally defines a round slot. The first connection seat 3′ also internally defines a first through hole, which extends through the first round base of the first rotation-limiting member 31′ and a bottom of the round slot.

The second connection seat 4′ has a fitting surface for bearing on a second side surface of the second link rod 2′ facing away from the first link rod 1′. On the fitting surface of the second connection seat 4′, there is provided a second rotation-limiting member, which includes a second round stub as a base and a second protrusion radially outward projected from the second round base. The second rotation-limiting member has an outer configuration matching an inner configuration of the second rotation-limiting slot 22′ on the second link rod 2′, so that the second rotation-limiting member is non-rotatably received in the second rotation-limiting slot 22′. The second connection seat 4′ has an outer surface facing away from the second link rod 2′. The outer surface of the second connection seat 4′ is extended in a direction opposite to the fitting surface to form a raised second locating seat 42′, which internally defines a rotation-limiting slot 421′. The second connection seat 4′ also internally defines a second through hole, which extends through the second round base of the second rotation-limiting member and a bottom of the rotation-limiting slot 421′.

The washer 5′ is wear-resistant and low-friction and is arranged between the first link rod 1′ and the second link rod 2′.

The nut is non-rotatably received in the rotation-limiting slot 421′, while a head of the bolt is rotatably received in the round slot. The bolt has an externally threaded shank being sequentially extended through the first through hole of the first connection seat 3′, the pivot hole 11′ on the first link rod 1′, the washer 5′, the pivot hole 21′ on the second link rod 2′, and the second through hole of the second connection seat 4′ to engage with the nut.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A pivotal connection mechanism for pivotally connecting a first rod and a second rod to each other, comprising:
a first connection seat having a first rotation-limiting member provided on a fitting surface thereof;
a second connection seat having a second rotation-limiting member provided on a fitting surface thereof;
a first rotation-limiting slot being provided on an outer side surface of the first rod facing away from the second rod;
a second rotation-limiting slot being provided on an outer side surface of the second rod facing away from the first rod; and
a pivot shaft being sequentially extended through the first connection seat, the first rod, the second rod, and the second connection seat and locked thereto;
wherein the first connection seat is attached to the first rod with the first rotation-limiting member non-rotatably engaged with the first rotation-limiting slot on the first rod; and the second connection seat is attached to the second rod with the second rotation-limiting member non-rotatably engaged with the second rotation-limiting slot on the second rod.

2. The pivotal connection mechanism as claimed in claim 1, further comprising a wear-resistant and low-friction washer arranged between the first and the second rod; wherein the pivot shaft is extended through the first connection seat, the first rotation-limiting member, the first rod, the washer, the second rod, the second rotation-limiting member and the second connection seat to be locked thereto.

3. The pivotal connection mechanism as claimed in claim 2, wherein the pivot shaft includes a bolt and a matching nut; the bolt having an externally threaded shank extended through the first connection seat, the first rotation-limiting member, the first rod, the washer, the second rod, the second rotation-limiting member, and the second connection seat to engage with the nut.

4. The pivotal connection mechanism as claimed in claim 3, wherein the first connection seat has an outer surface facing away from the first rod; the outer surface of the first connection seat being extended in a direction opposite to the fitting surface of the first connection seat to form a raised first locating seat, which internally defines a round slot matching a head of the bolt; and the bolt head being rotatably received in the round slot.

5. The pivotal connection mechanism as claimed in claim 3, wherein the second connection seat has an outer surface facing away from the second rod; the outer surface of the second connection seat being extended in a direction opposite to the fitting surface of the second connection seat to form a raised second locating seat, which internally defines a rotation-limiting slot matching the nut; and the nut being non-rotatably received in the rotation-limiting slot.

6. The pivotal connection mechanism as claimed in claim 1, wherein the first rotation-limiting member has an outer configuration matching an inner configuration of the first rotation-limiting slot on the first rod; and the second rotation-limiting member has an outer configuration matching an inner configuration of the second rotation-limiting slot on the second rod.

7. The pivotal connection mechanism as claimed in claim 6, wherein the first rotation-limiting member includes a first round stub as a base and a first protrusion radially outward projected from the first round base; and the second rotation-limiting member includes a second round stub as a base and a second protrusion radially outward projected from the second round base.

8. The pivotal connection mechanism as claimed in claim 1, wherein the pivotally connected first and second rods have a pivot point located at their respective middle area, so that the first and the second rod cross each other and form a foldable scissor linkage.

9. The pivotal connection mechanism as claimed in claim 1, wherein the pivotally connected first and second rods have a pivot point located close to their respective one end; and wherein the pivotal connection mechanism further comprises a first reinforcing cap fixedly fitted on the pivotal end of the first rod to correspond and adjoin to the first connection seat, and a second reinforcing cap fixedly fitted on the pivotal end of the second rod to correspond and adjoin to the second connection seat.

10. The pivotal connection mechanism as claimed in claim 9, wherein the first rod is further provided near the pivotal end thereof with a fixed first locating dot, and the first reinforcing cap is internally provided with a first locating blind hole or a first undercut for correspondingly engaging with the first locating dot; and
wherein the second rod is further provided near the pivotal end thereof with a fixed second locating dot, and the second reinforcing cap is internally provided with a second locating blind hole or a second undercut for correspondingly engaging with the second locating dot.
